(19) United States
(12) Patent Application Publication
(10) Pub. No.: US 2026/0359496 A1
(43) Pub. Date: Nov. 12, 2026

(54) SECURITY ARCHITECTURES

(71) Applicant: Cirrus Logic International Semiconductor Ltd., Edinburgh (GB)

(72) Inventors: John P. LESSO, Edinburgh (GB); Scott P. WARRICK, Austin, TX (US)

(73) Assignee: Cirrus Logic International Semiconductor Ltd., Edinburgh (GB)

(21) Appl. No.: 19/448,405

(22) Filed: Jan. 14, 2026

Related U.S. Application Data
(60) Provisional application No. 63/802,995, filed on May 9, 2025.

(51) Int. Cl. G06F 21/86; H04L 9/06; H04L 9/32

(52) U.S. Cl. CPC G06F 21/86; H04L 9/0656; H04L 9/3278

(57) ABSTRACT

Security circuitry for securing a device, comprising: a stored secret; an authentication output for outputting an authentication result based on the stored secret; and processing circuitry configured to: monitor a condition of the device; adjust the authentication result based on the monitored condition.

### TECHNICAL FIELD

The present disclosure relates to security architectures, such as those incorporating physically unclonable functions (PUFs).

### BACKGROUND

Challenge-response architectures are widely used in security systems. Physically unclonable functions (PUFs) are commonly used in cryptographic key generation, often as part of challenge-response architectures to store secret keys. Traditional PUFs leverage uncontrollable manufacturing variations in physical materials to produce unique and unpredictable responses to given inputs (referred to as challenges).

A stable PUF is a PUF which produces a consistent, identical output for a given input. When a stable PUF is required, either PUF enrolment (testing bit stability) or error correction may be performed. These mechanisms can introduce significant complexity, power, and area overhead.

### SUMMARY

According to a first aspect of the disclosure, there is provided a1. Security circuitry for securing a device, comprising: a stored secret; an authentication output for outputting an authentication result based on the stored secret; and processing circuitry configured to: monitor a condition of the device; adjust the authentication result based on the monitored condition.

The processing circuitry may be configured to adjust the authentication result by deleting or destroying the stored secret.

The processing circuitry may be configured to adjust the authentication result by replacing a genuine authentication result obtained using the stored secret with an imitation result.

Based on the monitored condition, the processing circuitry is configured to: replace the stored secret with an imitation secret comprising a pseudo random number (PRN).

The processing circuitry may be configured to generate the replacement key using a PRN generator.

The security circuitry may further comprise: an embedded fuse, wherein the processing circuitry is configured to cause the embedded fuse to blow in response to a detected change in the monitored condition.

Monitoring the condition may comprise detecting one or more of the following: a single use of the security circuitry to generate the authentication output; a number of uses of the security circuitry to generate the authentication output exceeding a use threshold; a single access of the stored secret; a number of accesses of the stored secret exceeding an access threshold; a number of reads of the authentication output exceeding an authentication read threshold; and an indication of tampering with the device or the security circuitry.

The processing circuitry may be configured to delete or destroy the stored secret in response to a change in state of the monitored condition.

The processing circuitry may comprise tamper detection circuitry configured to output the indication of tampering with the device or the security circuitry.

The tamper detection circuitry may comprise one or more sensors configured to detect tampering of the device or the security circuitry.

The one or more sensors may comprise an optical sensor configured to detect removal of a physical component of the device.

The one or more sensors may comprise a resistive sensor coupled to an internal layer of a package of the device. The resistive sensor may be configured to detect opening or bending of the device.

The one or more sensors may comprise a capacitive sensor configured to detect a physical change to a contact of the device.

The one or more sensors may comprise a temperature sensor configured to monitor thermal variations of the device to detect thermal tampering of the device.

The one or more sensors may be configured to detect a glitch in timing or voltage of the security circuitry.

The security circuitry may further comprise a challenge input for receiving a challenge signal. The processing circuitry may be configured to generate the authentication result based on the challenge input.

The security circuitry may further comprise a physically unclonable function (PUF).

The processing circuitry may be configured to generate the secret key using the PUF.

The processing circuitry may be configured to generate the secret key during manufacture of the security circuitry or the device.

According to another aspect of the disclosure, there is provided an integrated circuit, comprising: the security circuitry as described above.

The integrated circuit may comprise a primary die, the security circuitry co-packaged with primary die.

According to another aspect of the disclosure, there is provided a device, comprising the security circuitry described above.

The device may comprise one of a smartphone, a communications device, a mobile computing device, a laptop computer, a tablet computer, a games console, a remote-control device, a home automation controller or a domestic appliance, a toy, a robot, an audio player, a video player, or a mobile telephone, a vehicle, and any component thereof.

According to another aspect of the disclosure, there is provided a method of securing a device, the method comprising: generating a cryptographic response signal based on a stored secret key; outputting an authentication result based on the stored secret key; monitoring a condition of the device; and adjusting the authentication result based on the monitored condition.

According to another aspect of the disclosure, there is provided security circuitry for securing a device, the security circuitry comprising: a stored secret; an authentication output for outputting an authentication result based on the stored secret; and processing circuitry configured to: monitor a condition of the device; in response to a change in the monitored condition, delete or destroy the stored secret and/or replace the stored secret with a random number.

According to another aspect of the disclosure, there is provided security circuitry for securing a device, the security circuitry comprising: a stored secret; an authentication output for outputting an authentication result based on the stored secret; and processing circuitry configured at manufacture of the security circuitry or assembly of the device to: verify the integrity of the device using the stored secret; and subsequent to the verification, delete or physically destroy the stored secret.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is a schematic diagram of a known cryptographic system;

FIG. 2 is a schematic diagram of a system comprising security circuitry;

FIG. 3 is a schematic diagram of a device comprising the security circuitry of FIG. 2; and

FIG. 4 is a flow chart illustrating a process which may be performed by the security circuitry of FIG. 2.

### DESCRIPTION OF EMBODIMENTS

Key-based authentication is a method of confirming the identity of an entity (e.g. person, device or system) using a secret (usually cryptographic) key. To verify the integrity of a secret key held by the entity as part of a key-based authentication process, a challenge C may be sent to the entity. The entity may then respond with a transformation (an authentication result or response R) of that challenge C which is transformed using their (private) key. The authentication result or response R can then be checked to verify the key and thus the entity's identity.

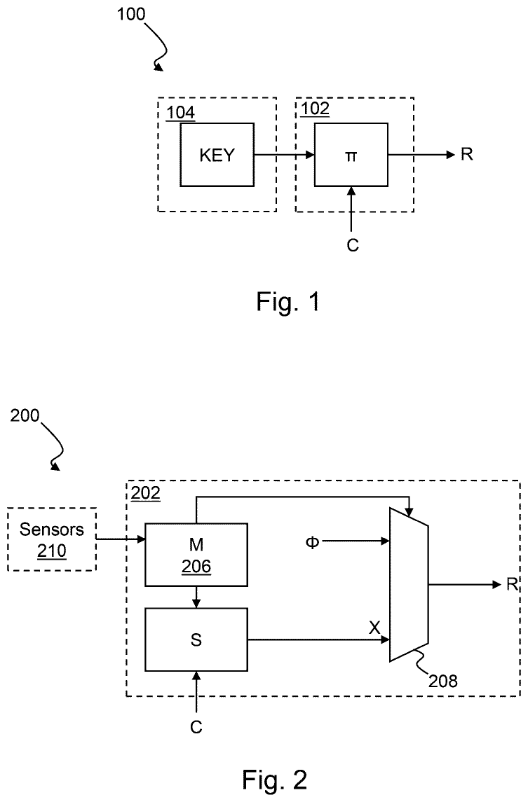

FIG. 1 is a schematic diagram of an example of the above key-based authentication scheme which may be implemented by a system 100 comprising processing circuitry 102 and memory 104. The challenge C is provided to a transformation function π implemented by the processing circuitry 102. The function π obtains a key KEY from the memory 104 and generates the authentication result or response R. The authentication result or response R may then be reviewed, for example by a verifier, to determine whether the key is valid. For example, the authentication result response R may be compared to an expected response to the challenge C.

Security-critical devices increasingly demand hardware security primitives that are resistant to tampering, invasive attacks, and operational misuse. Traditional physically unclonable functions (PUFs) offer unique fingerprints but require complex error correction and are susceptible to attacks when long-term reliability is needed.

Embodiments of the present disclosure aim to address or at least ameliorate one or more of these challenges by providing a simplified one-time-use PUF. A secret key is stored for use, whilst providing a mechanism to securely manage the secret and respond to tampering events.

FIG. 2 is a schematic diagram of a system 200 according to embodiments of the present disclosure comprising security circuitry 202.

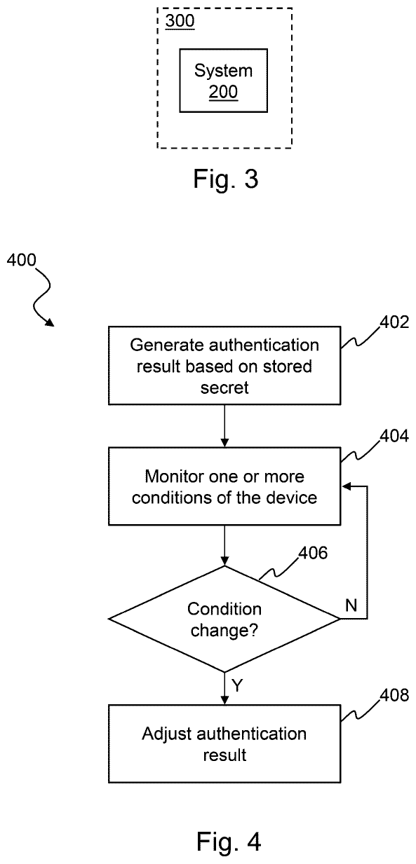

Optionally, as shown in FIG. 3, the system 200 may be incorporated into a device 300 which the system 200 may be configured to secure. The device 300 may be any conceivable electronic device capable of being secured by the system 200. Non-limiting examples of the device 300 include a smartphone, a communications device, a mobile computing device, a laptop computer, a tablet computer, a games console, a remote-control device, a home automation controller or a domestic appliance, a toy, a robot, an audio player, a video player, and a vehicle. The device 300 may alternatively comprise a component of any of the above listed devices, such as a camera of a smartphone or a battery module for a vehicle.

The security circuitry 202 comprises a stored secret S, monitoring circuitry 206, and selection circuitry 208.

The stored secret S (or secret key S) may comprise a conventional challenge-key function, such as that described with reference to FIG. 1. As such, in response to a challenge C, the secret S may generate an interim result X. Additionally, or alternatively, the stored secret S may be derived using a physically unclonable function (PUF). The interim result X may be generated by probing or reading the PUF, in which case the challenge C is equivalent to such probing.

The monitoring circuitry 206 may be configured to monitor operation of the system 200, a state of the stored secret S, and/or operation of the device 300. For example, as will be described in more detail below, the monitoring circuitry 206 may be configured to modify, delete, wipe, or destroy the secret S if certain monitored conditions are met.

The selection circuitry 208 is controlled by the monitoring circuitry 206 to output an authentication output R which corresponds either to the (genuine) interim result X generated using the secret S or an imitation result φ, such as a random or pseudo random number. As such, the monitoring circuitry 206 may comprise a pseudo-random number generator (not shown) or may access memory to obtain one or more random numbers. The monitoring circuitry 206 may be configured to monitor a condition (or multiple conditions) of the system 200 or the device 300 and select which of the interim result X and the imitation result φ to output based on the one or more monitored conditions.

Any one of the stored secret S, the interim resultX, the imitation result φ may be stored in memory of the system 200. Such memory may be provided as part of the monitoring circuitry 206. The memory may comprise non-volatile random-access memory (NVRAM). Memory provided in the monitoring circuitry 206 may be used to store additional information, such as a monitored condition, and/or flags indicating that a condition or plurality of conditions have been met.

In addition to outputting an imitation result φ as the authentication result R, the security circuitry 202 may be configured to perform one or more additional steps to improve security.

For example, the security circuitry 202 may be configured to delete the secret S from memory. Such deletion may be based on the monitored condition.

For example, the security circuitry 202 may be configured to replace the secret S with a replacement secret or key, such as the imitation result φ or a random or pseudo random number.

For example, the security circuitry 202 may be configured to permanently augment a hardware component of the system 200 or a device in which the system 200 is comprised. For example, the security circuitry 202 may be configured to blow an embedded fuse of the system 200 or a device in which the system 200 is comprised.

To determine the monitored condition, the system 200 may further comprise one or more sensors 210 which may be used by the monitoring circuitry 206 to detect tampering of the system 200 or the device 300 as will be described in more detail below.

Monitoring the condition may comprise detecting a change in state of a condition.

A monitored condition may comprise any conceivable condition of the system 200 or the device 300.

For example, the monitored condition may comprise that the security circuitry 202 has been used to generate the authentication result R. For example, the condition may be that the security circuitry 202 has already been used to generate the authentication result R. For example, the condition may be that a number of uses of the security circuitry 202 to generate the authentication result R exceeds a threshold. In either case, if the condition is met, i.e. secret S has already been used once or more than a threshold number of times to generate the authentication result R, resulting in the interim result X being output as the authentication result R once or more than a threshold number of times, such use may lead to subsequent output by the selection circuitry 208 of the imitation result φ as opposed to the interim result X.

In addition to or as an alternative to the condition comprising that the security circuitry has been used, the monitored condition may comprise that the authentication result R has been read a single time or more than a threshold number of times. With that condition being met, the monitoring circuitry 206 may signal to output the imitation result φ as the authentication result R.

In addition to or as an alternative to the above, the monitored condition may comprise a tamper condition which may indicate whether the system 200 or the device 300 has been tampered with. It will be appreciated that PUFs tend to rely on fine-grained, uncontrollable variations in physical properties for the entropy. As such, any external interference can alter their response or enable reverse engineering. Thus, to secure the stored secret S, particularly when implemented using a PUF, the monitoring circuitry 206 may be configured to account for potential third party or bad actor attacks. Such attacks may include environmental, electrical and/or operational attacks.

To determine the tamper condition, the monitoring circuitry 206 may use the one or more sensors 210 to detect tampering of the system 200. The one or more sensors 210 may be configured to monitor physical, electrical, and/or environmental parameters of the system 200 and/or the device 300.

The one or more sensors 210 may comprise one or more environmental sensors, such as optical sensors, temperature sensors, and radiation sensors. Optical sensors may be used to detect light exposure which may indicate de-lidding of an integrated circuit (IC) into which the system 200 is incorporated. Environmental tampering may comprise methods such as optical probing, temperature manipulation, and exposure to radiation. Focused ion beams or laser fault injection can be used to observe or disturb internal signals of a chip, particularly in analog-or voltage-based PUFs. Techniques such as light shielding, active mesh sensors, and on-chip temperature or light detectors can be used to detect such conditions. For example, a diode or other optical sensor may be used to detect light ingress via a package sidewall.

Upon detection of a change in an environmental condition as detected by the one or more sensors 210, the monitoring circuitry 206 may determine a tamper condition, i.e. that the system 200 or device 300 has been tampered with. If tampering is detected, the monitoring circuitry 206 may trigger an alert, disable itself, or invalidate the stored secret S as described above.

The one or more sensors 210 may comprise one or more electrical sensors. Electrical tampering targets the underlying physical parameters of the PUF. This includes injecting voltages or currents that cause changes in parasitic capacitances, resistances, or threshold voltages. This is particularly relevant in analog-or voltage-based PUFs. An attacker might attempt to modify internal charge distribution or interfere with sensing circuitry. Thus, the one or more sensors 210 may comprise on-chip sensors for measuring voltage or current anomalies, redundant PUF instances for cross-checking, or self-checking calibration mechanisms to detect uncharacteristic shifts in physical parameters. The one or more electrical sensors may, for example, comprise capacitive sensors configured to detect a change in one or more physical contacts (e.g. pins) of the system 200 or the device 300.

The one or more electrical sensors may be configured to monitor electrical parameters of coupling between security circuitry (which may be provided on a security die) and a co-packaged primary die. If monitored characteristics deviate from initial or characterized parameters, the monitoring circuitry may flag a potential tampering action. The one or more sensors 210 may comprise one or more active shield layers. Such layers may be configured to sense physical intrusion into the system 200 or the device 300. For example, the one or more sensors 210 may comprise resistive sensors coupled to an internal layer of a package of the device 300 configured to detect bending of the device 300 or a component thereof.

The one or more sensors 210 may comprise operational sensors configured to detect tampering in the operation of the system 200 or the device 300. Operational tampering, such as glitch attacks, exploits timing vulnerabilities by injecting clock or power glitches during operation. Time-based PUFs such as arbiter PUFs are especially vulnerable, as timing errors can change the path evaluation outcome, allowing attackers to manipulate or probe the response space. Protection against this class of attack includes using clock monitors, randomized evaluation timing, and response filtering to reject out-of-spec or odd measurements.

In view of this, the one or more sensors 210 may comprise operational sensors configured to detect changes in clocks or glitches in signals which may have been introduced by a bad actor. Such sensors 210 may comprise one or more clock or glitch detectors. Such sensors may be configured to identify abnormalities in timing signals (e.g. clock signals) or voltages (e.g. supply voltages). Such abnormalities may be indicative of a bad actor tampering with the system 200 or the device 300.

Having regard for the above, the system 200 may be operable one of a plurality of modes.

For example, the system 200 may be configurable in a one-time access (or limited access) mode. During manufacturing or initial configuration of the system 200 or installation of the system 200 into the device 300, a device-specific challenge-response (CR) pair may be obtained and stored securely. Depending on the device configuration, the system 200 may be arranged to only allow one reading of the stored secret S or key, or readings up to a threshold number. After the allowed authentication session(s), the monitoring circuitry 206 may be configured to cause the stored secret S to be securely wiped or replaced with random data.

In an example of the above, during the initial testing of the security circuitry 202, the system 200, or the device 300, challenge/response pairs can be derived from the stored secret S and stored in memory of the monitoring circuitry 206. As noted above, this memory may also be used to flag that an initial challenge response has been given (i.e. the authentication output R has been output). At assembly time (assembly of the device 300 or a system into which the device 300 is being assembled), the stored secret S (e.g. PUF) may be verified. Upon successful verification, the monitoring circuitry 206 may confirm the system 200 and/or the device 300 is genuine and store a verification result in memory. The monitoring circuitry 206 may store a flag indicating that the final authentication output R has been given. The stored secret S may then be erased or wiped.

In another example, the system 200 may be configurable in a tamper detection mode in which the system 200 is configured to augment an authentication result, or wipe, delete, or destroy the stored secret S upon detection of tampering using any of the techniques described above.

FIG. 4 is a flow diagram illustrating a process 400 which may be implemented by the security circuitry 202 of FIG. 2.

At step 402 the security circuitry 202 is configured to generate the authentication result R based on the stored secret S. The authentication result R may be stored in memory of the security circuitry 202, such as NV RAM of the monitoring circuitry 206. In addition to storing the result R, the monitoring circuitry 206 may be configured to store a flag indicating that the authentication result R has been generated based on the stored secret S.

At step 404, the monitoring circuitry 206 may be configured to monitor one or more conditions of the device 300, such as environmental, electrical, and/or operation conditions of the device 300. Such monitoring may comprise using the one or more sensors 210. Examples of such monitoring are described above. Such monitoring may be particularly useful for the tamper detection use-case described above. Monitoring may additionally or alternatively comprise determining whether the stored secret S has already been used or has been used more than a threshold amount. Such monitoring may be particularly useful for the one-time access mode describe above.

At step 406, if a change in the monitored condition or conditions is not detected, the process 400 returns to step 404 where the monitoring circuitry 206 continues to monitor the one or more conditions of the device 300. If, however, a condition change is detected, the process 400 proceeds to step 408.

At step 408, the authentication result R is adjusted. Such adjustment may be performed in a variety of ways. For example, the stored authentication result R may be replaced with the imitation result. Additionally, or alternatively, the stored secret S may be deleted, wiped, or replaced with a replacement key and a new result may be generated based on the adjusted stored secret S.

Thus, the process 400 may be used both to handle the above one-time access mode in which a stored secret S is used to validate the device 300 or a system into which it is being assembled, and to handle the tamper detection mode in which the stored secret S is wiped or removed, or a permanent alteration (e.g. fuse blow) of the device 300 is performed to fend off bad actors.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog TM or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. Security circuitry for securing a device, comprising:
a stored secret;
an authentication output for outputting an authentication result based on the stored secret; and
processing circuitry configured to:
monitor a condition of the device; and
adjust the authentication result based on the monitored condition.

2. The security circuitry of claim 1, wherein the processing circuitry is configured to adjust the authentication result by deleting or destroying the stored secret.

3. The security circuitry of claim 1, wherein the processing circuitry is configured to adjust the authentication result by replacing a genuine authentication result obtained using the stored secret with an imitation result.

4. The security circuitry of claim 3, wherein based on the monitored condition, the processing circuitry is configured to:
replace the stored secret with an imitation secret comprising a pseudo random number (PRN).

5. The security circuitry of claim 4, wherein the processing circuitry is configured to generate the replacement key using a PRN generator.

6. The security circuitry of claim 1, further comprising:
an embedded fuse, wherein the processing circuitry is configured to cause the embedded fuse to blow in response to a detected change in the monitored condition.

7. The security circuitry of claim 1, wherein monitoring the condition comprises detecting one or more of the following:
a single use of the security circuitry to generate the authentication output;
a number of uses of the security circuitry to generate the authentication output exceeding a use threshold;
a single access of the stored secret;
a number of accesses of the stored secret exceeding an access threshold;
a number of reads of the authentication output exceeding an authentication read threshold; and
an indication of tampering with the device or the security circuitry.

8. The security circuitry of claim 7, wherein the processing circuitry is configured to delete or destroy the stored secret in response to a change in state of the monitored condition.

9. The security circuitry of claim 7, wherein the processing circuitry comprises tamper detection circuitry configured to output the indication of tampering with the device or the security circuitry.

10. The security circuitry of claim 9, wherein the tamper detection circuitry comprises:
one or more sensors configured to detect tampering of the device or the security circuitry.

11. The security circuitry of claim 10, wherein the one or more sensors comprises one or more of:
an optical sensor configured to detect removal of a physical component of the device;
a resistive sensor coupled to an internal layer of a package of the device, the resistive sensor configured to detect opening or bending of the device;
a capacitive sensor configured to detect a physical change to a contact of the device; and
a temperature sensor configured to monitor thermal variations of the device to detect thermal tampering of the device.

12.-14. (canceled)

15. The security circuitry of claim 10, wherein the one or more sensors is configured to detect a glitch in timing or voltage of the security circuitry.

16. The security circuitry of claim 1, further comprising a challenge input for receiving a challenge signal, the processing circuitry configured to generate the authentication result based on the challenge input.

17. The security circuitry of claim 1, further comprising a physically unclonable function (PUF), wherein the processing circuitry is configured to generate the secret key using the PUF.

18. (canceled)

19. The security circuitry of claim 17, wherein the processing circuitry is configured to generate the secret key during manufacture of the security circuitry or the device.

20. An integrated circuit, comprising:
the security circuitry of claim 1.

21. The integrated circuit of claim 20, comprising:
a primary die, the security circuitry co-packaged with primary die.

22. (canceled)

23. A device comprising the security circuitry of claim 1, wherein the device comprises one of a smartphone, a communications device, a mobile computing device, a laptop computer, a tablet computer, a games console, a remote-control device, a home automation controller or a domestic appliance, a toy, a robot, an audio player, a video player, or a mobile telephone, a vehicle, and any component thereof.

24. A method of securing a device, the method comprising:
generating a cryptographic response signal based on a stored secret key;
outputting an authentication result based on the stored secret key;
monitoring a condition of the device; and
adjusting the authentication result based on the monitored condition.

25. Security circuitry for securing a device, the security circuitry comprising:
a stored secret;
an authentication output for outputting an authentication result based on the stored secret; and
processing circuitry configured to:
monitor a condition of the device; and
in response to a change in the monitored condition, delete or destroy the stored secret and/or replace the stored secret with a random number.

26. Security circuitry for securing a device, the security circuitry comprising:
a stored secret;
an authentication output for outputting an authentication result based on the stored secret; and
processing circuitry configured at manufacture of the security circuitry or assembly of the device to:
verify the integrity of the device using the stored secret; and
subsequent to the verification, delete or physically destroy the stored secret.
